(19) United States
(12) Patent Application Publication
(10) Pub. No.: US 2020/0213855 A1
(43) Pub. Date: Jul. 2, 2020

(54) SYSTEMS AND METHODS FOR FRAUD DETECTING IN A TRANSPORTATION SERVICE

(71) Applicant: DiDi Research America, LLC, Mountain View, CA (US)

(72) Inventors: Xiaoyong Yi, Mountain View, CA (US); Yu Wang, Mountain View, CA (US); Fengmin Gong, Mountain View, CA (US)

(73) Assignee: DiDi Research America, LLC, Mountain View, CA (US)

(21) Appl. No.: 16/236,970

(22) Filed: Dec. 31, 2018

(51) Int. Cl. H04W 12/12; G06Q 50/30; G06Q 50/26; H04L 29/06; H04L 9/32; H04W 12/06; H04W 4/029

(52) U.S. Cl. CPC H04W 12/12; G06Q 50/30; G06Q 50/265; H04W 4/029; H04L 9/3231; H04W 12/06; H04L 63/0861

(57) ABSTRACT

Embodiments of the disclosure provide systems and methods for fraud detecting in a transportation service. An exemplary method may include receiving user data from a terminal device associated with a user providing transportation service. The user data may include a location associated with the transportation service and positioning data of a geographical positioning system. The method may also include determining a first fingerprint based on the positioning data. The method may further include determining whether the first fingerprint matches a first reference fingerprint of a transmitter of the geographical position system corresponding to the location. Moreover, the method may include triggering a first fraud alert when the first fingerprint does not match the first reference fingerprint.

### RELATED APPLICATIONS

This application is related to concurrently filed U.S. non-provisional applications entitled “Systems and Methods for Onboard Fraud Detection in a Transportation Service” by Xiaoyong Yi, Yu Wang, and Fengmin Gong, and entitled “Systems and Methods for Device Fingerprint Determination in a Transportation Service” by Xiaoyong Yi, Yu Wang, and Fengmin Gong, both of which are incorporated by reference in their entireties.

### TECHNICAL FIELD

The present disclosure relates to systems and methods for fraud detecting in a transportation service, and more particularly to, systems and methods for detecting positioning data fraud and terminal device identification fraud in transportation services.

### BACKGROUND

Positioning data fraud and terminal device fraud have negative impact on the fairness and efficiency of transportation services such as ride-hailing (also referred to as ride-sharing) services. For example, transportation service providers (e.g., drivers) may fake their GPS location information to create fake trips, thus tricking the transportation service platform and make unjustified profit. Fraudsters may also run faked ride-sharing trips to gain awards for accomplishing certain amount of transactions. As each faked mobile device can be assigned to a phone number, using Short Message Service (SMS) to verify is not enough to prevent such fraud activities.

Existing fraud detecting methods collect different types of signal communication channels' features such as Access Point (AP) using a transportation service application and report the collected features back to a cloud server where the signals are analyzed to detect the fraud. However, as the signals used for verification are easy to fake but hard to verify, those methods cannot guarantee that the terminal device connected to the cloud is an authenticated terminal device. GPS spoofing detecting methods such as distortion detection require extra components such as detection logics to the GPS receiver chip and/or antenna. This will increase the cost and complexity to the fraud detecting system and process.

Embodiments of the disclosure address the above problems by methods and systems for fraud detecting in a transportation service based on determining fingerprints from user data and comparing the determined fingerprints with reference fingerprints pre-set and stored to the server to enhance detecting accuracy and efficiency.

### SUMMARY

Embodiments of the disclosure provide a method for fraud detecting in a transportation service. An exemplary method may include receiving user data from a terminal device associated with a user providing the transportation service. The user data may include a location associated with the transportation service and positioning data of a geographical positioning system. The method may also include determining a first fingerprint based on the positioning data and determining whether the first fingerprint matches a first reference fingerprint of a transmitter of the geographical position system corresponding to the location. Moreover, the method may also include triggering a first fraud alert when the first fingerprint does not match the first reference fingerprint.

Embodiments of the disclosure also provide a system for fraud detecting in a transportation service. An exemplary system may include a communication interface configured to receive user data from a terminal device associated with a user providing the transportation service. The user data may include a location associated with the transportation service and positioning data of a geographical positioning system. The system may also include a storage configured to store the user data. The system may also include at least one processor coupled to the storage. The at least one processor is configured to determine a first fingerprint based on the positioning data. Moreover, the at least one processor is further configured to determine whether the first fingerprint matches a first reference fingerprint of a transmitter of the geographical position system corresponding to the location and trigger a first fraud alert when the first fingerprint does not match the first reference fingerprint.

Embodiments of the disclosure further provide A non-transitory computer-readable medium storing instructions that, when executed by one or more processors, cause the one or more processors to perform a method for fraud detecting in a transportation service. The method may include receiving user data from a terminal device associated with a user providing the transportation service. The user data may include a location associated with the transportation service and positioning data of a geographical positioning system. The method may also include determining a first fingerprint based on the positioning data and determining whether the first fingerprint matches a first reference fingerprint of a transmitter of the geographical position system corresponding to the location. The method may further include triggering a first fraud alert when the first fingerprint does not match the first reference fingerprint.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary fraud detecting system in a transportation service, according to embodiments of the disclosure.

FIG. 2 illustrates a block diagram of an exemplary fraud detecting system, according to embodiments of the disclosure.

FIG. 3 illustrates a flowchart of an exemplary method for fraud detecting in a transportation service, according to embodiments of the disclosure.

FIG. 4 illustrates a flowchart of another exemplary method for fraud detecting in a transportation service, according to embodiments of the disclosure

FIG. 5 illustrates a flowchart of a further exemplary method for fraud detecting in a transportation service, according to embodiments of the disclosure

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

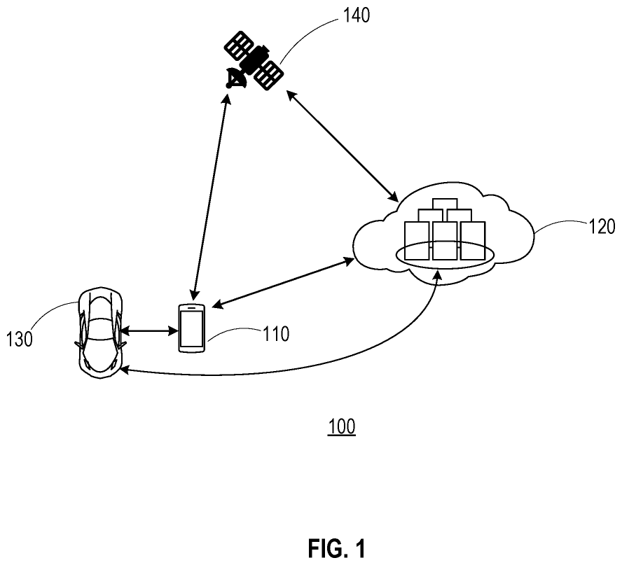

FIG. 1 illustrates a schematic diagram of an exemplary fraud detecting system 100 in a transportation service, according to embodiments of the disclosure. As shown in FIG. 1, a transmitter (e.g., a satellite 140) may communicate with a server 120 to provide satellite signal for determining a satellite fingerprint. A terminal device 110 may also communicate with satellite 140 to receive positioning data.

Terminal device 110 may include any suitable device that can interact with a user, e.g., a smart phone, a tablet, a wearable device, a computer, or the like, that can receive positioning signals from satellite 140. In some embodiments, terminal device 110 may be a standalone device or integrated inside another device, e.g., a vehicle, a mobile phone, a wearable device, a camera, etc. It is contemplated that terminal device 110 may be any kind of movable device or equivalent structures equipped with any suitable satellite navigation module that enables terminal device 110 to obtain satellite signals.

It is contemplated that in some embodiments, satellite 140 may be part of a geographical position system such as satellite navigation system. The satellite navigation system may be a global navigation satellite system such as a Global Positioning System (GPS), a Global Navigation Satellite System (GLONASS), a BeiDou-2 Navigation Satellite System (BDS) or a European Union's Galileo system. The satellite navigation system may also be a regional navigation satellite system such as a BeiDou-1 system, a NAVigation with Indian Constellation (NAVIC) system or a Quasi-Zenith Satellite System (QZSS). Terminal device 110 may include a high sensitivity GPS receiver, a conventional GPS receiver, a hand-held receiver, an outdoor receiver, a sport receiver or any of a smart phone, a tablet, a wearable device, a computer, or the like with a satellite navigation module built in. In some embodiments, terminal device 110 may be connected to satellite 140 directly, through Assisted or Augmented GPS, through an intermediary device (e.g., a cell tower or a station), or via any other communication method that could transmit satellite signals (e.g., satellites broadcast microwave signals) or provide orbital data or almanac for satellite 140 (e.g., Mobile Station Based assistance) to terminal device 110.

Terminal device 110 may also be configured to communicate with a service vehicle 130 to facilitate various functions such as transmitting and receiving transportation service requests, playing video/audio contents, making calls, or the like. Transportation service request may include a current location of the passenger, a destination of the requested transportation service, a request time, or the like. Generally, passenger location can be the same or substantially close to a location of the terminal device 110. However, it is contemplated that, passenger location can also differ from the location of the terminal device 110, even if the transportation service request is sent from terminal device 110. For example, a user can request a transportation service from a computer for her friend, who is distant from this user. In that case, the user may manually provide passenger location on terminal device 110. Location of the passenger, terminal device 110 and/or the destination of the transportation request may be used to determine fraud. For example, server 120 may determine a satellite fingerprint based on the location data and/or positioning information associated with the transportation service transmitted by and received from terminal device 110.

Consistent with some embodiments, service vehicle 130 may be a vehicle configured to providing transportation service. It is contemplated that service vehicle 130 may be an electric vehicle, a fuel cell vehicle, a hybrid vehicle, or a conventional internal combustion engine vehicle. Service vehicle 130 may have a body and at least one wheel. The body may be any body style, such as a sports vehicle, a coupe, a sedan, a pick-up truck, a station wagon, a sports utility vehicle (SUV), a minivan, or a conversion van. In some embodiments, service vehicle 130 may include a pair of front wheels and a pair of rear wheels. However, it is contemplated that service vehicle 130 may have more or less wheels or equivalent structures that enable vehicle 130 to move around. Service vehicle 130 may be configured to be all-wheel drive (AWD), front wheel drive (FWR), or rear wheel drive (RWD). In some embodiments, service vehicle 130 may be configured to be operated by an operator occupying the vehicle, remotely controlled, and/or autonomous.

In addition, terminal device 110 may be connected to service vehicle 130 via a network, such as a Wireless Local Area Network (WLAN), a Wide Area Network (WAN), wireless networks such as radio waves, a cellular network, a satellite communication network, and/or a local or short-range wireless network (e.g., Bluetooth™) for transmitting vehicle navigation information.

Terminal device 110 may also be configured to communicate with server 120. In some embodiments, server 120 may be a local physical server, a cloud server (as illustrated in FIG. 1), a virtual server, a distributed server, or any other suitable computing device. Server 120 may also be a general-purpose server or a proprietary device specially designed for fraud detecting. It is contemplated that, server 120 can be a stand-alone system (e.g., a server) or an integrated component of a stand-alone server.

In some embodiments, service vehicle 130 may also be configured to communicate with server 120. For example, service vehicle 130 may determine a fingerprint of terminal device 110 indicating the identity of terminal device 110, encrypt the fingerprint and transmit the fingerprint to server 120 for further identification/authentication. For example, service vehicle 130 may determine a Bluetooth fingerprint of terminal device 110 based on establishing Bluetooth communication with terminal device 110 and may encrypt the Bluetooth fingerprint (e.g., using symmetric key or public key schemes) before transmitting the Bluetooth fingerprint to server 120.

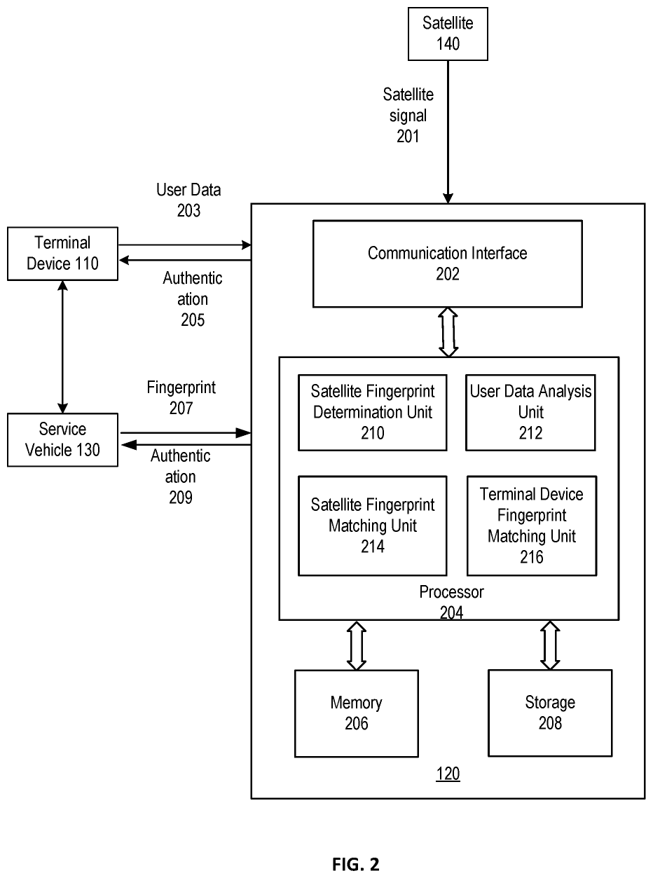

FIG. 2 illustrates a block diagram of an exemplary system for fraud detecting in a transportation service, according to embodiments of the disclosure. Consistent with the present disclosure, server 120 may receive satellite signal 201 from satellite 140 and receive user data 203 from and transmit an authentication 205 to terminal device 110. Server 120 may also receive fingerprint 207 from and transmit another authentication 209 to service vehicle 130. Fingerprint 207 may be provided by service vehicle 130 equipped with modules configured to determine the fingerprint of terminal device 110 and modules configured to encrypt the fingerprint before transferring the fingerprint to server 120. Server 120 may be configured to compare the received fingerprint with pre-stored reference fingerprints to determine fraudulent activities in a transportation service.

In some embodiments, as shown in FIG. 2, server 120 may include a communication interface 202, a processor 204, a memory 206, and a storage 208. In some embodiments, server 120 may have different modules in a single device, such as an integrated circuit (IC) chip (implemented as an application-specific integrated circuit (ASIC) or a field-programmable gate array (FPGA)), or separate devices with dedicated functions. In some embodiments, one or more components of server 120 may be located in a cloud computing environment or may be alternatively in a single location or distributed locations. Components of server 120 may be in an integrated device or distributed at different locations but communicate with each other through a network (not shown).

Communication interface 202 may send data to and receive data from components such as terminal device 110, service vehicle 130, and satellite 140 via communication cables, a Wireless Local Area Network (WLAN), a Wide Area Network (WAN), wireless networks such as radio waves, a cellular network, satellite communication links, and/or a local or short-range wireless network (e.g., Bluetooth™), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive data such as satellite data (e.g., satellite signal 201) from satellite 140 as well as user data 203 from terminal device 110. In some embodiments, communication interface 202 may also receive fingerprint 207 (e.g., terminal device fingerprint) from service vehicle 130. In some embodiments, user data 203 received from terminal device 110 may include fingerprint 207. Communication interface 202 may further provide the received data to storage 208 for storage or to processor 204 for processing. Communication interface 202 may also receive authentications generated by processor 204 upon verifying the transportation service and provide the authentication (e.g., authentication 205 and/or authentication 209) to terminal device 110, service vehicle 130, or any remote device via a network.

Processor 204 may include any appropriate type of general-purpose or special-purpose microprocessor, digital signal processor, or microcontroller. Processor 204 may be configured as a separate processor module dedicated to fraud detecting in a transportation service. Alternatively, processor 204 may be configured as a shared processor module for performing other functions unrelated to fraud detecting.

As shown in FIG. 2, processor 204 may include multiple modules, such as a satellite fingerprint determination unit 210, a user data analysis unit 212, a satellite fingerprint matching unit 214, and a terminal device fingerprint matching unit 216, and the like. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 210-216 all within one processor 204, it is contemplated that these units may be distributed among multiple processors located near or remotely with each other.

Satellite fingerprint determination unit 210 may be configured to determine a reference satellite fingerprint of a satellite based on the satellite data (e.g., satellite signal 201) received from satellite 140. In some embodiments, fingerprint determination unit 210 may determine satellite fingerprints of one or more satellites used to provide positioning data to a geographical area over a certain time period and store the satellite fingerprints as reference fingerprints to identify the satellites. For example, in city A, all the GPS positioning information acquired may be received from a set of satellite B1, B2, Bn over a certain time period (e.g., in a day, over a few hours, etc.). In this case, the satellite fingerprint determination unit 210 may determine the satellite fingerprints of satellites B1, B2, Bn based on raw data received from these satellites and store the satellite fingerprints as reference fingerprints to uniquely identify satellites B1, B2, Bn, if server 120 is used for detecting fraud in city A over the specified time period. In some embodiments, satellite fingerprint may be determined based on an amplitude profile and/or a phase profile included in the satellite raw data. For example, satellite fingerprint determination unit 210 may determine the fingerprint of a satellite based on the precise positioning service (PPS) code and/or the standard positioning service (SPS) code used to modulate the carrier signal of a GPS satellite navigational positioning and identification information. In another example, a satellite fingerprint may also be identified based on the 50 bit per second (bps) message used to modulate the GPS signal that includes primarily the orbit and timing information of the satellite. In some embodiments, the determined satellite fingerprint(s) may be stored in memory 206 and/or storage 208 as reference satellite fingerprint(s).

After receiving user data 203 from terminal device 110, user data analysis unit 212 may analyze user data 203 to determine whether fraudulent activities are involved. In some embodiments, user data 203 may include a location associated with the transportation service (e.g., a location of the terminal device 110 provided by terminal device 100) and positioning data of a geographical positioning system (e.g., raw data received by terminal device 110 from the satellite(s) of the geographical position system). User data analysis unit 212 may first extract positioning data from user data 203 and provide the positioning data such as the raw data received from satellite(s) to satellite fingerprint determination unit 210 to determine a satellite fingerprint of a satellite from which terminal device 110 receives the signal. For example, similar to determining the reference fingerprint, satellite fingerprint determination unit 210 may use the positioning data extracted by user data analysis unit 212 to determine the fingerprint of the satellite (e.g., the actual satellite that transmits raw data to terminal device 110) based on the precise positioning service (PPS) code and/or the standard positioning service (SPS) code used to modulate the carrier signal of a GPS satellite navigational positioning and identification information. In another example, the satellite fingerprint may also be identified based on the 50 bit per second (bps) message used to modulate the GPS signal that includes primarily the orbit and timing information of the satellite. Because it is relatively hard to alter the positioning data (e.g., raw data received from a satellite), the positioning data (e.g., as part of the user data 203) received from terminal device 110 may contain information of the satellite that actually sends signals to terminal device 110. Therefore, the satellite fingerprint determined from the raw satellite data may reveal information of the actual satellite that transmits signals to terminal device 100. The determined satellite fingerprint may be provided to satellite fingerprint matching unit 214 for further processing.

User data analysis unit 212 may also extract a location associated with the transportation service from user data 203 and provide the location to satellite fingerprint determination unit 210 to determine, based on the location, a proper reference satellite fingerprint for matching purposes. The location is supposedly decoded by terminal device 110 from satellite signals but may be tampered. For example, terminal device 110 may bypass the actual location decoded from actual satellite signals and replace the actual location with a fake one. In this case, the fake location may be included in user data 203 and received by server 120. Based on the received location (may or may not be the actual location), satellite fingerprint determination unit 210 may determine one or more satellites that in fact provide positioning service to that received location and determine the fingerprint(s) of the corresponding satellite(s). For example, user data may include location L and positioning data P. Positioning data P may be raw data received by terminal device 110 from one or more satellites, such as a satellite 51. Positioning data P are relatively hard to alter so they are considered authentic data. Location L is a location (e.g., geographical coordinates) decoded by terminal device 110 indicating the current location of terminal device 110. Comparing to positioning data P, location L is relatively easy to alter. Suppose location L is a fake location, then it is likely that the satellite(s) corresponding to the fake location L (e.g., the satellite(s) providing positioning data that, after decoding, yield the fake location L) is different from satellite 51. By comparing the fingerprint of the satellite corresponding to the raw positioning data and the fingerprint of the satellite corresponding to the location, server 120 can determine if the location provided by terminal device 110 is authentic or fake.

After receiving the satellite fingerprint determined from positioning data, satellite fingerprint matching unit 214 may determine whether the satellite fingerprint matches with a reference satellite fingerprint. The reference satellite fingerprint may be determined by satellite fingerprint determination unit 210 based on the location extracted from user data. For example, if the location indicates a location L, satellite fingerprint determination unit 210 may determine or select the fingerprint(s) of one or more satellites that provide positioning service/signals to location L and use the fingerprint(s) as reference fingerprint(s). In some embodiments, satellite fingerprint matching unit 214 may compare the precise positioning service (PPS) code and/or the standard positioning service (SPS) used to modulate satellite signal 201 and the positioning data in user data 203. In some embodiments, satellite fingerprint matching unit 214 may determine whether the orbit and/or the timing information associated with satellite signal 201 and the positioning data in user data 203 match. If satellite fingerprint matching unit 214 determine that the satellite fingerprint determined from positioning data does not match the reference satellite fingerprint, satellite fingerprint matching unit 214 may trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some other embodiments, the fraud alert may be transmitted to both the transportation service provider and/or a rider (not shown) for safety protection reasons. On the other hand, if the satellite fingerprint determined from the positioning data matches the reference satellite fingerprint, satellite fingerprint matching unit 214 may authenticate the location associated with the transportation service. In some embodiments, satellite fingerprint matching unit 214 may, through communication interface 202, transmit authentication 205 back to terminal device 110, indicating that the location associated with the transportation service is autenticated.

Terminal device fingerprint matching unit 216 may be configured to compare a terminal device fingerprint of terminal device 110 and a reference terminal device fingerprint that is predetermined and stored in storage 208. In some embodiments, the terminal device fingerprint may be associated with a phone number, a Bluetooth™ fingerprint, an International Mobile Equipment Identity (IMEI), or any other information indicating an identity of the terminal device. In some embodiments, the reference terminal device fingerprint may be acquired anytime before terminal device 110 initiates a transportation service. For example, a Bluetooth™ fingerprint reader or scanner may be used to determine the Bluetooth™ fingerprint of terminal device 110 when terminal device 110 is registered as a terminal device facilitating the transportation services. The Bluetooth™ fingerprint reader or scanner may transmit the determined Bluetooth™ fingerprint to server 120 and store the fingerprint in memory 206 and/or storage 208 for further matching purposes.

In some embodiments, the terminal device fingerprint of terminal device 110 may be determined by terminal device 110 and may be transmitted to server 120 for matching purposes. For example, terminal device 110 may have certain application or a module within the transportation service application that may extract the information indicating the identity of a terminal device and determine the terminal device fingerprint based on the information. In some other embodiments, service vehicle 130 may determine the terminal device fingerprint of terminal device 110 (e.g., fingerprint 207) and transmit the terminal device fingerprint to server 120 directly or through terminal device 110 (e.g., user data 203 may include the terminal device fingerprint). In some embodiments, service vehicle 130 may encrypt the terminal device fingerprint (e.g., using symmetric key or public key schemes) before transmitting the terminal device fingerprint to server 120 or terminal device 110 (terminal device 110 may in turn transmit the encrypted terminal device fingerprint to server 120). This can prevent leaking of terminal device information, and thus increase the security of implementing the system and method disclosed herein. Server 120 may store the fingerprint in storage 208 for further matching purposes. For example, service vehicle 130 may establish connection with terminal device 110 and determine the terminal device fingerprint of terminal device 110 based on information exchanged with terminal device 110. In some embodiments, service vehicle 130 may have an individual module or a module built-in another device that can extract the information indicating the identity of terminal device 110 (e.g., service vehicle 130 may establish Bluetooth™ communication with terminal device 110 and determine the Bluetooth™ fingerprints of terminal device 110 based on the Bluetooth™ signal received from terminal device 110). In some embodiments, user data analysis unit 212 may determine the terminal device fingerprint based on user data 203 transmitted to server 120. For example, user data 203 may include information indicating the International Mobile Equipment Identity (IMEI) of terminal device 110. User data analysis unit 212 may determine the terminal device fingerprint (e.g., IMEI in this scenario) based on user data 203.

In some embodiments, terminal device fingerprint matching unit 216 may compare and/or match fingerprint 207 with the reference terminal device fingerprint. For example, terminal device fingerprint matching unit 216 may use the rise time signature of the terminal device to match the reference terminal device fingerprint. In some other embodiments, physical layer fingerprints (physical layer authentication solutions) may be used to match the terminal device fingerprint of terminal device 110 with the reference terminal device fingerprint.

When terminal device fingerprint matching unit 216 determines that the terminal device fingerprint does not match the reference terminal device fingerprint, terminal device fingerprint matching unit 216 may also trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some other embodiments, the fraud alert may be transmitted to both the transportation service provider and a rider (not shown) for safety reasons. On the other hand, when terminal device fingerprint matching unit 216 determines that the terminal device fingerprint matches the reference terminal device fingerprint, terminal device fingerprint matching unit 216 may authenticate terminal device 110. In some embodiments, terminal device fingerprint matching unit 216 may transmit, through communication interface 202, authentication 209 back to service vehicle 110 indicating that the identity of terminal device 110 is authenticated.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform fraud detecting herein. For example, memory 206 and/or storage 208 may be configured to store program(s) that may be executed by processor 204 to determine satellite fingerprints based on satellite signal.

Memory 206 and/or storage 208 may be further configured to store information and data used by processor 204. For instance, memory 206 and/or storage 208 may be configured to store the various types of data (e.g., user data, terminal device fingerprint, reference fingerprints, etc.) transmitted by terminal device 110, service vehicle 130 and satellite 140. Memory 206 and/or storage 208 may also store intermediate data such as reference satellite signal, and matching results, etc. The various types of data may be stored permanently, removed periodically, or disregarded immediately after each frame of data is processed.

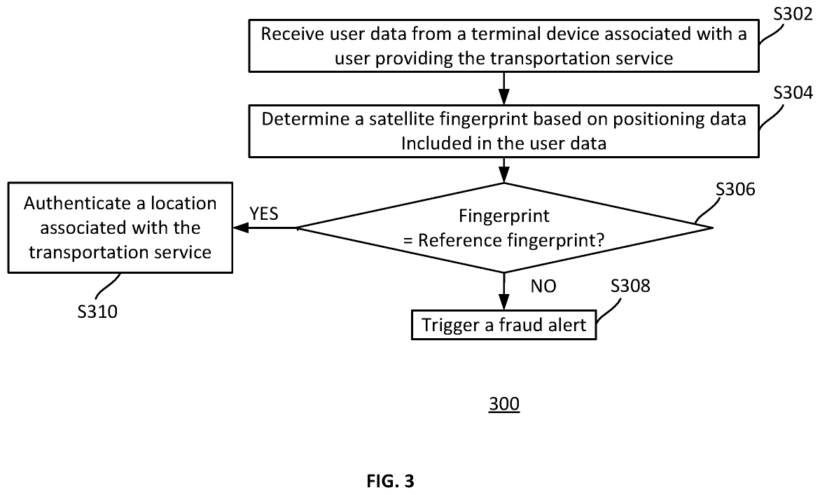

FIG. 3 illustrates a flowchart of an exemplary method for fraud detecting in a transportation service, according to embodiments of the disclosure. In some embodiments, method 300 may be implemented by server 120. However, method 300 is not limited to that exemplary embodiment and may be implemented jointly by server 120, terminal device 110, and/or service vehicle 130. Method 300 may include steps S302-S308 as described below. It is to be appreciated that some of the steps may be optional to perform the disclosure provided herein. Further, some of the steps may be performed simultaneously, or in a different order than shown in FIG. 3.

In step S302, server 120 may receive user data from a terminal device associated with a user providing the transportation service. For example, user data may include a location associated with the transportation service (e.g., location of the passenger or the real time location of the service vehicle provided by terminal device 110) and positioning data of a geographical positioning system (e.g., raw data received from satellite(s) by terminal device 110). The user data may be preprocessed to reduce data irrelevant to satellite fingerprint determination process and provide positioning data to the next step.

In step S304, server 120 may determine a satellite fingerprint based on positioning data included in the user data. For example, server 120 may use the positioning data such as the raw data received from satellite(s) by terminal device 110 to determine a satellite fingerprint of a satellite from which the terminal device actually received the signal. For example, server 120 may determine the fingerprint of the satellite based on the precise positioning service (PPS) code and/or the standard positioning service (SPS) code used to modulate the carrier signal of a GPS satellite navigational positioning and identification information. In another example, satellite fingerprint may be determined based on the 50 bit per second (bps) message used to modulate the GPS signal that includes primarily the orbit and timing information of the satellite.

In step S306, server 120 may determine if the determined satellite fingerprint matches a reference fingerprint. For example, the reference fingerprint may be determined based on the location received from terminal device 110, identifying a satellite that provides positioning service/signals to the location in the relevant time period when the location is received. Server 120 may compare the precise positioning service (PPS) code and/or the standard positioning service (SPS) used to modulate satellite signals of the reference satellite and the fingerprint determined from the positioning data in user data 203. In another example, server 120 may determine whether the orbit and/or the timing information associated with satellite signal of the reference satellite and the fingerprint determined from the positioning data in the user data 203 match.

If server 120 determines that the determined satellite fingerprint does not match the reference satellite fingerprint, method 300 proceeds to step S308, in which server 120 may trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some embodiments, the fraud alert may be transmitted to both the transportation service provider and a rider (not shown) for safety reasons.

If the determined fingerprint matches the reference fingerprint, method 300 proceeds to step S310, in which server 120 may authenticate the location associated with the transportation service. In some embodiments, server 120 may transmit an authentication back to terminal device 110 indicating that the location associated with the transportation service is authenticated.

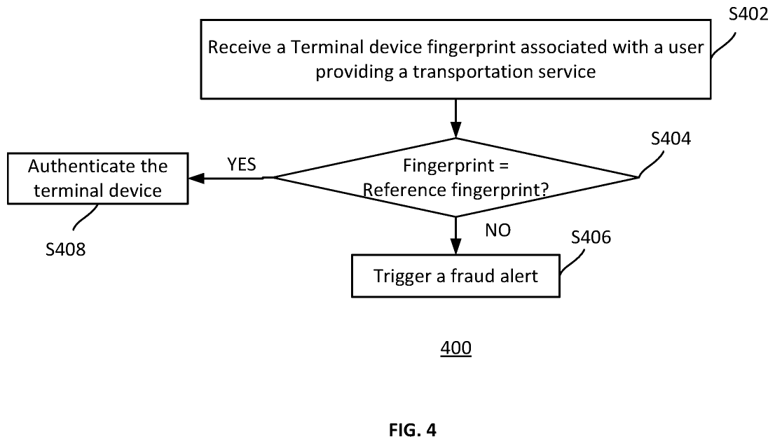

FIG. 4 illustrates a flowchart of another exemplary method 400 for fraud detecting in a transportation service, according to embodiments of the disclosure. In some embodiments, method 400 may be implemented by server 120. However, method 400 is not limited to that exemplary embodiment and may be implemented jointly by server 120, terminal device 110, and/or service vehicle 130. Method 400 may include steps S402-S408 as described below. It is to be appreciated that some of the steps may be optional to perform the disclosure provided herein. Further, some of the steps may be performed simultaneously, or in a different order than shown in FIG. 4.

In step S402, server 120 may receive a terminal device fingerprint associated with a user providing transportation service. In some embodiments, the fingerprint may be a terminal device fingerprint of terminal device 110 used by the transportation service provider. In some embodiments, the terminal device fingerprint may be determined by terminal device 110 and may be transmitted to server 120 for matching purposes. For example, terminal device 110 may have certain application or a module within the transportation service application that may extract the information indicating the identity of the terminal device and determine the terminal device fingerprint based on the information. In some embodiments, service vehicle 130 may determine the terminal device fingerprint of the terminal device and transmit the terminal device fingerprint (e.g., Bluetooth™ fingerprint) to server 120, which may store the fingerprint in storage 208 for further processing. In some embodiments, service vehicle 130 may encrypt the terminal device fingerprint (e.g., using symmetric key or public key schemes) before transmitting the terminal device fingerprint to server 120 or terminal device 110 (terminal device 110 may in turn transmit the encrypted terminal device fingerprint to server 120). Service vehicle 130 may establish a connection with terminal device 110 and determine the terminal device fingerprint of the terminal device based on the information exchanged with the terminal device. For example, the service vehicle may have an individual module or a module built-in another device that can extract the information indicating the identity of the terminal device (e.g., the service vehicle may establish Bluetooth™ communication with the terminal device and determine the Bluetooth™ fingerprint of the terminal device based on the Bluetooth™ signal received from the terminal device).

In step S404, server 120 may determine if the terminal device fingerprint matches a reference terminal device fingerprint. For example, server 120 may use the rise time signature of the terminal device to match the reference fingerprint. In some embodiments, physical layer fingerprints (physical layer authentication solutions) may be used to match the fingerprint of the terminal device and the reference fingerprint.

In some embodiments, the reference fingerprint may be acquired any time before the terminal device initiates a transportation service. For example, a Bluetooth™ fingerprint reader or scanner may be used to determine the Bluetooth™ fingerprint of the terminal device when the terminal device is registered as a terminal device facilitating the transportation services. The Bluetooth™ fingerprint reader or scanner may transmit the determined Bluetooth™ fingerprint to server 120, which may store the fingerprint in storage 208 as the reference fingerprint of the terminal device for matching purposes.

If server 120 determines that the fingerprint does not match the reference fingerprint, method 400 proceeds to step S406, in which server 120 may trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some embodiments, the fraud alert may be transmitted to both the transportation service provider and a rider (not shown) for safety reasons.

If server 120 determines that fingerprint does match the reference fingerprint, method 400 proceeds to step S408, in which server 120 may authenticate the terminal device. In some embodiments, server 120 may transmit an authentication back to terminal device 110 indicating that the terminal device is authenticated.

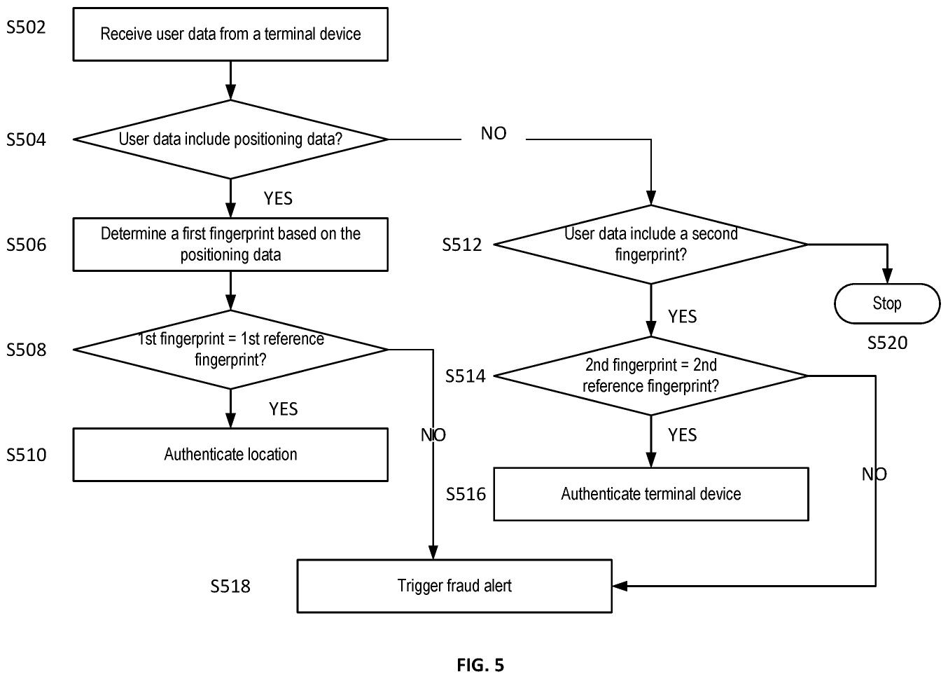

FIG. 5 illustrates a flowchart of another exemplary method for fraud detecting in a transportation service, according to embodiments of the disclosure. In some embodiments, method 500 may be implemented by server 120. However, method 500 is not limited to that exemplary embodiment and may be implemented jointly by server 120, terminal device 110, and/or service vehicle 130. Method 500 may include steps S502-S520 as described below. It is to be appreciated that some of the steps may be optional to perform the disclosure provided herein. Further, some of the steps may be performed simultaneously, or in a different order than shown in FIG. 5.

In step S502, server 120 may receive user data from a terminal device (e.g., terminal device 110) associated with a user providing the transportation service. For example, user data may include a location associated with the transportation service (e.g., location of the passenger, a destination of the requested transportation service and/or the real time location of the service vehicle provided by terminal device 110), positioning data of a geographical positioning system (e.g., raw data received from satellite(s) by terminal device 110) and information indicating the identity of the terminal device such as a phone number, a Bluetooth™ fingerprint, an International Mobile Equipment Identity (IMEI), etc.

In step S504, server 120 may determine if the user data include positioning data. If yes, method 500 proceeds to step S506, in which server 120 may determine a first fingerprint (e.g., a satellite fingerprint) based on positioning data included in the user data. For example, server 120 may use the positioning data such as the raw data received from satellite(s) by terminal device 110 to determine a satellite fingerprint of a satellite from which the terminal device actually received the signal. For example, server 120 may determine the fingerprint of the satellite based on the precise positioning service (PPS) code and/or the standard positioning service (SPS) code used to modulate the carrier signal of a GPS satellite navigational positioning and identification information. In another example, satellite fingerprint may be determined based on the 50 bit per second (bps) message used to modulate the GPS signal that includes primarily the orbit and timing information of the satellite.

In step S508, server 120 may determine if the first fingerprint matches a reference fingerprint. For example, the reference fingerprint may be determined based on the location received from terminal device 110, identifying a satellite that provides positioning service/signals to the location in the relevant time period when the location is received from terminal device 110. Server 120 may compare the precise positioning service (PPS) code and/or the standard positioning service (SPS) used to modulate the fingerprint determined from the positioning data in the user data 103 with the reference fingerprint. In another example, server 120 may determine whether the orbit and/or the timing information associated with satellite signal of the reference satellite and the fingerprint determined from the positioning data in the user data 203 matches.

If server 120 determines that the determined satellite fingerprint does not match the reference satellite fingerprint, method 500 proceeds to step S510, in which server 120 may trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some embodiments, the fraud alert may be transmitted to both the transportation service provider and the rider (not shown) for safety reasons.

Otherwise, if server 120 determines that the satellite fingerprint determined from the positioning data does match the reference satellite fingerprint, method 500 proceeds to step S510, in which server 120 may authenticate the location associated with the transportation service. In some embodiments, server 120 may transmit an authentication back to terminal device 110 indicating locations associated with the transportation service are authenticated.

Referring back to step S504, if server 120 determines that the user data 203 does not include a positioning data, method 500 proceeds to step S512 where server 120 may determine if the user data include a second fingerprint (e.g., a terminal device fingerprint such as a Bluetooth™ fingerprint). If the user data does not include a second fingerprint, method 500 proceeds to step S520 and the system stops the fraud detecting process.

Otherwise, server 120 may determine if the second fingerprint matches with a second reference terminal device fingerprint. For example, server 120 may use the rise time signature of terminal device 110 to perform fingerprint matching. In some embodiments, physical layer fingerprints (physical layer authentication solutions) may be used to match the second fingerprint with the second reference fingerprint.

In some embodiments, the reference fingerprint may be acquired any time before the terminal device initiates a transportation service. For example, a Bluetooth™ fingerprint reader or scanner may be used to determine the Bluetooth™ fingerprint of the terminal device when the terminal device is registered as a terminal device facilitating the transportation services. The Bluetooth™ fingerprint reader or scanner may transmit the determined Bluetooth™ fingerprint to server 120, which may store the fingerprint in storage 208 as the reference fingerprint of the terminal device for further matching purposes.

If server 120 determines that the second fingerprint does match the second reference fingerprint, method 500 proceeds to step S516, in which server 120 may authenticate the terminal device. In some embodiments, server 120 may transmit an authentication back to terminal device 110 indicating that the terminal device is authenticated.

Otherwise, if server 120 determines that the second fingerprint does not match the second reference fingerprint, method 500 proceeds to step S518, in which server 120 may trigger a fraud alert and/or may terminate the transportation service. In some embodiments, the fraud alert may be transmitted to the transportation service platform for the platform to take further actions (e.g., disfranchise the license of the fraudsters, or contact third party authorities such as local police stations). In some embodiments, the fraud alert may be transmitted to both the transportation service provider and a rider (not shown) for safety reasons.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for fraud detecting in a transportation service, comprising:
receiving user data from a terminal device associated with a user providing the transportation service, the user data comprising a location associated with the transportation service and positioning data of a geographical positioning system;
determining a first fingerprint based on the positioning data;
determining whether the first fingerprint matches a first reference fingerprint of a transmitter of the geographical position system corresponding to the location; and
triggering a first fraud alert when the first fingerprint does not match the first reference fingerprint.

2. The method of claim 1, further comprising authenticating the location associated with the transportation service when the first fingerprint matches the first reference fingerprint.

3. The method of claim 1, further comprising determining the first reference fingerprint based on data received from the transmitter.

4. The method of claim 1, wherein:
the positioning data comprise an amplitude profile or a phase profile; and
the method further comprises determining the first fingerprint based on the amplitude profile or the phase profile.

5. The method of claim 1, wherein:
the user data comprise a second fingerprint identifying the terminal device; and
the method comprises:
determining whether the second fingerprint matches a second reference fingerprint; and
triggering a second fraud alert when the second fingerprint does not match the second reference fingerprint.

6. The method of claim 5, further comprising authenticating the terminal device when the second fingerprint matches the second reference fingerprint.

7. The method of claim 5, wherein the second fingerprint is determined by a service vehicle in communication with the terminal device.

8. The method of claim 5, wherein the second fingerprint is determined by the terminal device based on identification information of the terminal device.

9. The method of claim 5, wherein the second fingerprint is encrypted.

10. The method of claim 9, further comprising:
decrypting the second fingerprint prior to determining whether the second fingerprint matches the second reference fingerprint.

11. The method of claim 1, comprising:
receiving information indicating an identity of the terminal device;
determining a second fingerprint identifying the terminal device based on the information;
determining whether the second fingerprint matches a second reference fingerprint; and
triggering a second fraud alert when the second fingerprint does not match the second reference fingerprint.

12. The method of claim 9, comprising:
authenticating the terminal device when the second fingerprint matches the second reference fingerprint.

13. A system for fraud detecting in a transportation service, comprising:
a communication interface configured to receive user data from a terminal device associated with a user providing the transportation service, the user data comprising a location associated with the transportation service and positioning data of a geographical positioning system;
a storage configured to store the user data; and
at least one processor coupled to the storage and configured to:
determine a first fingerprint based on the positioning data;
determine whether the first fingerprint matches a first reference fingerprint of a transmitter of the geographical position system corresponding to the location; and
trigger a first fraud alert when the first fingerprint does not match the first reference fingerprint.

14. The system of claim 13, wherein the at least one processor is further configured to authenticate the location associated with the transportation service when the first fingerprint matches the first reference fingerprint.

15. The system of claim 13, wherein the at least one processor is further configured to determine the first reference fingerprint based on data received from the transmitter.

16. The system of claim 13, wherein:
the positioning data comprise an amplitude profile or a phase profile; and
the at least one processor is further configured to determine the first fingerprint based on the amplitude profile or the phase profile.

17. The system of claim 13, wherein:
the user data comprise a second fingerprint identifying the terminal device; and
the at least one processor is further configured to:
determine whether the second fingerprint matches a second reference fingerprint; and
trigger second fraud alert when the second fingerprint does not match the second reference fingerprint.

18. The system of claim 17, wherein the at least one processor is further configured to authenticate the terminal device when the second fingerprint matches the second reference fingerprint.

19. The system of claim 13, wherein the at least one processor is further configured to:
receive information indicating an identity of the terminal device;
determine a second fingerprint identifying the terminal device based on the information;
determine whether the second fingerprint matches a second reference fingerprint; and
trigger a second fraud alert when the second fingerprint does not match the second reference fingerprint.

20. A non-transitory computer-readable medium storing instructions that, when executed by one or more processors, cause the one or more processors to perform a method for fraud detecting in a transportation service comprising:
receiving user data from a terminal device associated with a user providing the transportation service, the user data comprising a location associated with the transportation service and positioning data of a geographical positioning system;
determining a first fingerprint based on the positioning data;
determining whether the first fingerprint matches a first reference fingerprint of a transmitter of the geographical position system corresponding to the location; and
triggering a first fraud alert when the first fingerprint does not match the first reference fingerprint.
